(19) United States
(12) Patent Application Publication
(10) Pub. No.: US 2009/0210554 A1
(43) Pub. Date: Aug. 20, 2009

(54) Non intrusive control process for an XDSL type transmission line

(75) Inventors: Jean Schmitt, Rouvres (FR); Dominique Le Foll, Devon (GB)

Correspondence Address: PEARNE & GORDON LLP, 1801 EAST 9TH STREET, SUITE 1200, CLEVELAND, OH, 44114-3108, US

(73) Assignee: Acterna IPMS, Trappes (FR)

(21) Appl. No.: 10/538,707

(22) PCT Filed: Dec. 16, 2003
(86) PCT No.: PCT/FR03/50177

§ 371 Date: Jun. 10, 2005

(30) Foreign Application Priority Data
Dec. 18, 2002 (FR) 02 16114

(51) Int. Cl. G06F 15/16

(52) U.S. Cl. 709/237

(57) ABSTRACT

The invention concerns a non intrusive control process of an xDSL transmission line from signals and messages exchanged between at least one emitter (1) to at least one receiver (2) at the end of or during a predefined handshaking procedure.

This process comprises the following steps:

a1. Analysing the type of signals exchanged between the emitter (1) and the receiver (2) during the establishment of the new contact,

b1. Establishing a diagnosis on the state of the line according to the result of step b1.

### TECHNICAL FIELD

The invention pertains to the field of the measurement of disturbances and pre-location of these disturbances in wide band xDSL (for x Digital Line Subscriber) transmission lines.

More specifically, the invention relates to a non-intrusive control process for an xDSL transmission line from an analysis of the signals and messages exchanged between at least one emitter and at least one receiver during a handshaking procedure.

The invention also relates to a device to carry out this process, comprising a measuring unit measuring unit capable of ensuring the continuity of the connection during the control procedure.

### STATE OF THE PRIOR ART

The Recommendation UIT-T G.994.1 (for the International Union of Telecommunications-Telecommunications standard sector) defines the signals and the messages as well as the exchanges procedures for these signals and messages between the xDSL digital line subscriber equipment when the operating modes of these equipments must be established and selected automatically, but prior to any signals specific to a given DSL recommendation are exchanged.

FIG. 1 diagrammatically shows the reference model of the system used in the said recommendation.

This system comprises a HSTU-C 1 emitter and a HSTU-R 2 receiver (HSTU Handshake transceiver unit), splitters 3, a local loop 4, a user terminal 5, a normal telephone 6 and a line connected to the switch of the switched telephone network 7.

According to the recommendation UIT-T G.994.1, to each type of xDSL operation (ADSL, for Asymmetric DSL, VDSL, for Very High data DSL, SDSL, for Single pair or Symmetric DSL, HDSL for High Bit Rate DSL . . . ) is associated a set of specific carriers that are obligatorily exchanged between the xDSL modems during a handshaking procedure. For each operating mode used by a G.994.1 station, the initial G.994.1 transmission from the station must comprise all of the carriers that are specific to this mode.

The control and test techniques of the xDSL lines of the prior art do not use this information. Consequently, to control an xDSL line transporting a wide band channel (data used by Internet for example) and a narrow band channel, telephone for example, it is necessary to disable the communications through these channels completely. Whereas, it may be useful to maintain a telephone communication during the control when this only concerns a wide band connection control, just as it may be useful to maintain a wide band connection if the control only concerns the telephone channel transporting the voice.

One purpose of the invention is to optimise the search and location of faults and breaks in a high rate xDSL transmission line by a non intrusive method.

### DESCRIPTION OF THE INVENTION

The invention concerns a non intrusive control process for an xDSL transmission line of the xDSL type from a prior analysis of the signals and messages exchanged between at least one emitter to at least receiver during a handshaking procedure.

To this end, the process of the invention comprises the following steps:
detecting and identifying the standardised carriers transmitted through the line to be checked,
analysing the spectral power of the xDSL signals exchanged,
establishing a diagnosis of the state of the line in function of the previous steps.

In one particular case, in the case of failure or in the case of a search for a more precise diagnosis, the process of the invention further comprises a step consisting of disabling the transmission of the wide band channel between the emitter and the receiver for a short instant so as to initialise a new handshaking procedure between the said emitter and the said receiver.

In one particular embodiment of the invention, the signals exchanged between the emitter 1 and the receiver 2 are defined by the standard ITU-T G.994.1.

The process of the invention comprises a step which consists of measuring the attenuation of the carriers detected to assess the distance between the telecommunications centre where the control equipment is installed and the subscriber.

The process of the invention is implemented by means of a control device comprising a measuring unit designed to evaluate the performances, to search for the faults and to establish the quality of the line and services transmitted, a switching module being capable of selectively connecting the measuring unit solely to the transmission channels to be controlled and keep active the other channels of the transmission line.

The process of the invention further includes means for detecting and identifying of the standardised carriers transmitted through the line to be controlled, and means of analysing the spectral power of the xDSL signals exchanged, means for establishing a diagnosis on the state of the line according to the analysis of the xDSL signals exchanges.

The device of the invention further comprises means for disabling the communication via the wide band channel between the emitter and the receiver for a short instant so as to initialise a new handshaking procedure between the said emitter and the said receiver.

### BRIEF DESCRIPTION OF THE DRAWINGS

Other characteristics and advantages of the invention will become clearer from the following description, given by way of a non restrictive example in reference to the appended figures in which:

FIG. 1 previously described, shows diagrammatically a reference model of the system used by the standard G.994.1,

FIG. 2 shows diagrammatically an xDSL connection,

FIG. 3 diagrammatically shows a block diagram illustrating the process of the invention,

FIG. 4 shows a signal detected when a receiver is active,

FIG. 5 diagrammatically shows a block diagram illustrating the steps of the process of the invention when the signal of FIG. 4 is detected,

FIG. 6 shows a signal detected when a pair of xDSL modems is being synchronised,

FIG. 7 diagrammatically shows a block diagram illustrating the steps of the process of the invention when the signal of FIG. 6 is detected,

FIG. 8 shows a signal detected when a tone and/or disturbances are present on the line controlled,

FIG. 9 diagrammatically shows a block diagram illustrating the steps of the process of the invention when a tone and/or disturbances are present on the line controlled,

FIG. 10 shows a signal detected when a pair of xDSL modems is synchronised,

FIG. 11 diagrammatically shows a block diagram illustrating the steps of the process of the invention when the signal of FIG. 10 is detected,

FIG. 12 shows a signal detected in the case of a problem on the downward channel,

FIG. 13 shows a signal detected in the case of a problem on the upward channel.

### DETAILED DESCRIPTION OF ONE PARTICULAR EMBODIMENT

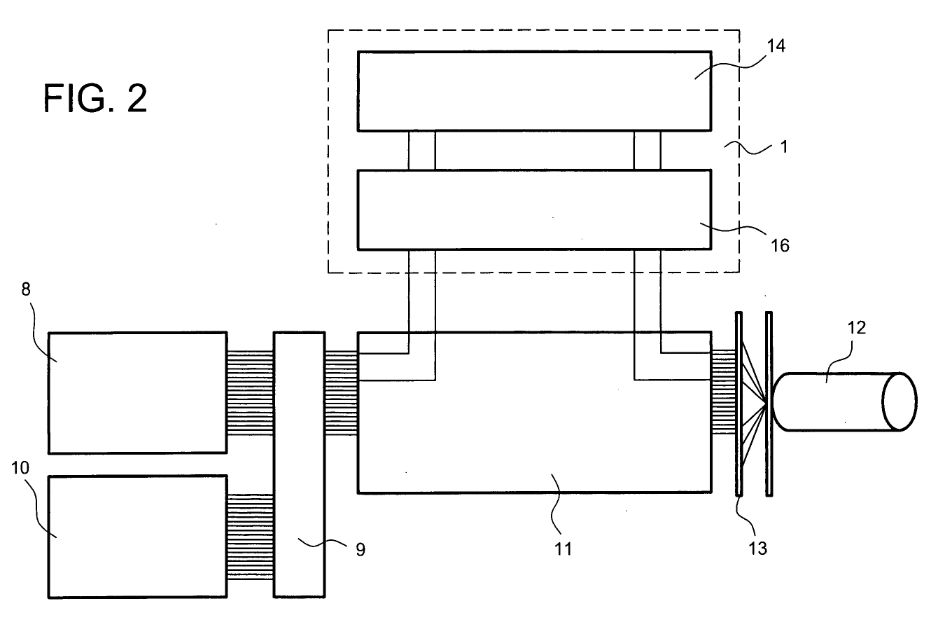

FIG. 2 shows diagrammatically an ADSL connection comprising multiplexing equipment 8 called DSLAM (for Digital Subscriber Line Access Multiplexer) providing the multiplexing of the ATM fluxes exchanged with the high rate network to the transport network, a splitter 9 designed to separate the transmission band reserved for the telephone service from the transmission band used for the high rate transmission. This splitter 9 ensures that there is sufficient cut off in order to avoid that the signals emitted on one of the frequency bands disturb the operation of the other. The splitter 9 is connected to the telephone network via a public switch 10 and to the high rate network via the DSLAM 8. On the user's side, a second splitter not shown, permits the signals emitted in the frequency transmission band used for the ADSL transmission to be recovered so that it may be transmitted to an ADSL modem connected to a local network or digital processing equipment such as a computer for example, and the signals emitted in the frequency transmission band used for the voice transmission to be recovered.

A matrix switch 11 (TAMS, for Test Access Matrix Switch) is fitted back along or down side the splitter 9 and the local loop 12 via a dispatcher 13. The matrix switch 11 is connected to a measuring unit 14 designed to assess the performances, search for faults and test the transmission line and the services provided via this line.

The device illustrated in FIG. 2 further comprises a switching module 16 which ensures the continuity of the xDSL services by selectively connecting the measuring unit 14 solely to the transmission channels to be controlled and by keeping active the other channels of the transmission line. This device is described in more detail in the French patent application No 02 11 241 filed by the applicant on Sep. 11, 2002.

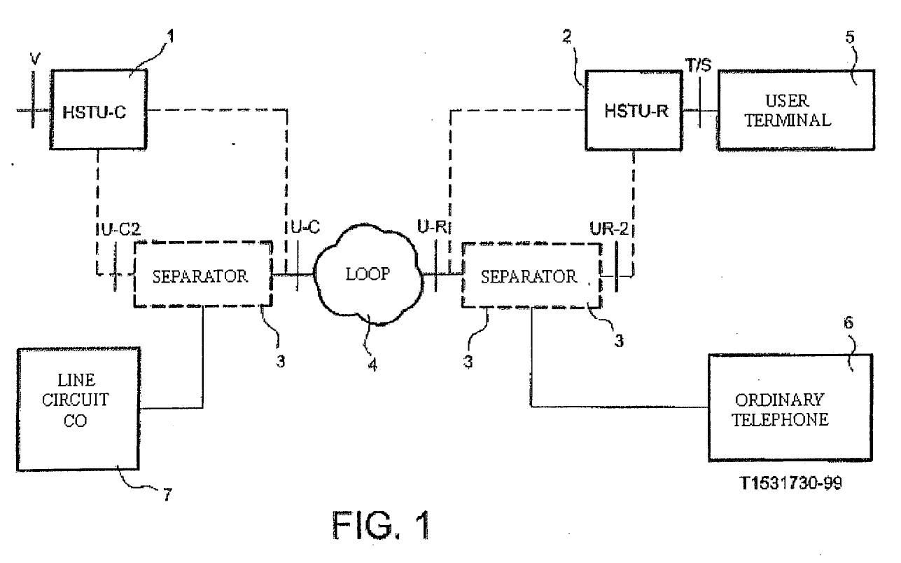

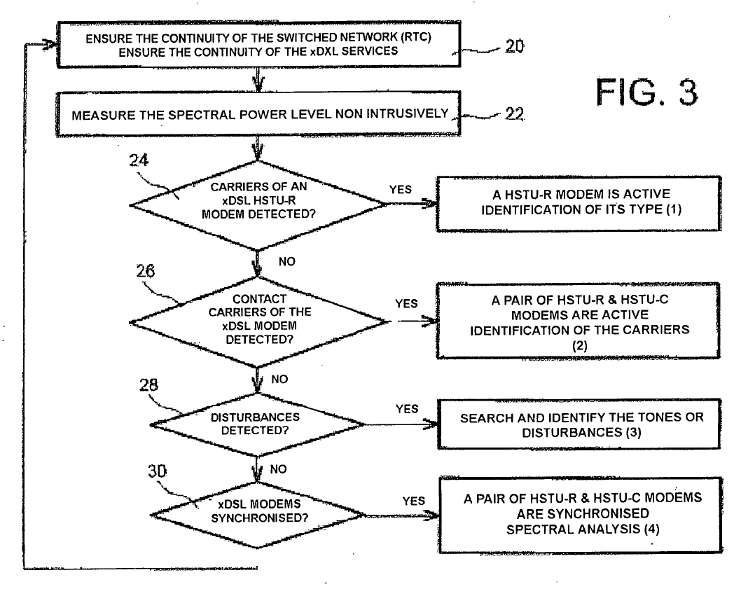

The non intrusive control process will now be described in reference to FIGS. 1 to 13.

A first step 20 of the process consists of disabling, if necessary, the wide band channel of the xDSL line for a short instant and forcing a new connection in order to initialise a handshaking procedure between the emitter and the receiver.

During this new handshaking procedure, or at any moment, the xDSL line is connected in high impedance to the measuring unit 14 which measures and analyses at step 22 the spectrum of all signals detected on the line in a frequency band at least equal to that of the xDSL services.

### Case Where a HSTU-R Type Modem is Active

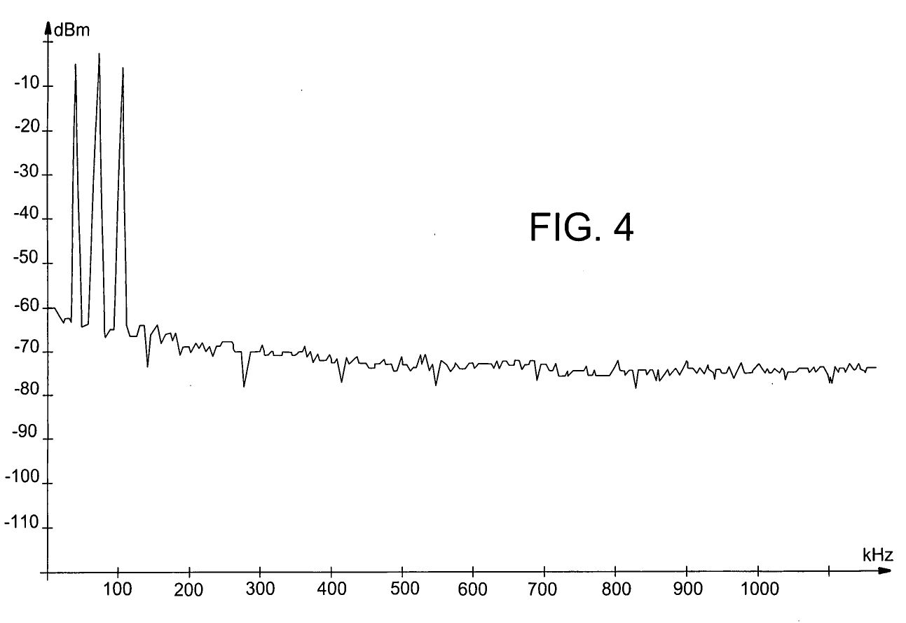

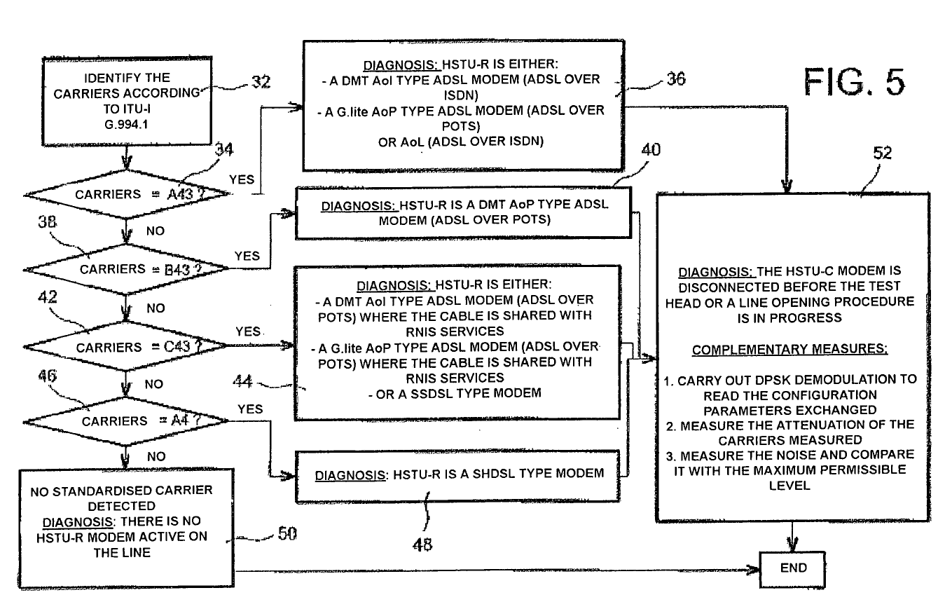

If a carrier such as that illustrated in FIG. 4 is detected, then the device deduces that a HSTU-R modem is active. The following step, illustrated by FIG. 5, consists of identifying (steps 32) the type of carrier from the following standardised types: A43, B43, C43, A4.

a—If the carrier is of the type A43 (step 34), then the diagnosis (steps 36) is made that it concerns:
either an ADSL DMT AoI type modem (for ADSL over ISDN, which is to say ADSL on an integrated services digital network) RNIS,
or an ADSL G.lite AoP type modem (for ADSL over POTS, which is to say ADSL on a local loops) or AoI type.

b—If the carrier is of the B43 type (step 38), then the diagnosis (step 40) is made that it concerns an ADSL DMT AoP type modem.

c—If the carrier is of the type C43 (step 42), then the diagnosis (step 44) is made that it concerns:
either an ADSL DMT AoP type modem where the cable is shared with RNIS services,
or an ADSL G.lite AoP type modem where the cable is shared with RNIS services,
or a SSDSL type modem.

d—If the carrier is of the A4 type (step 46), then the diagnosis (step 48) is made that it concerns a modem of the G.SHDSL type.

e—If (step 50) the carrier does not belong to any of the standardised types described above, then the diagnosis is made that it there is no active HSTU-R modem on the line.

In the case of the carrier being of the A43, B43, C43 or A4 type, the control device of the invention emits the following diagnosis: the HSTU-C modem is disconnected upstream of the measuring unit 14 (step 52) or a handshaking procedure is in progress.

Furthermore, the measuring unit 14 carries out the following operations:

1. A DPSK demodulation to read the configuration parameters exchanged,

2. Measurement of the attenuation of the carriers detected, if the attenuation per kilometre at the frequency of the carriers detected is known, this information permits the evaluation and verification of the coherency of the line length between the telecommunications centre where the control equipment is installed and the subscriber.

3. Measurement of the noise and comparison of this measurement with the maximum permissible level according to the standard.

### Case Where a Pair of HSTU-R and HSTU-C Modems is Active and Being Synchronised

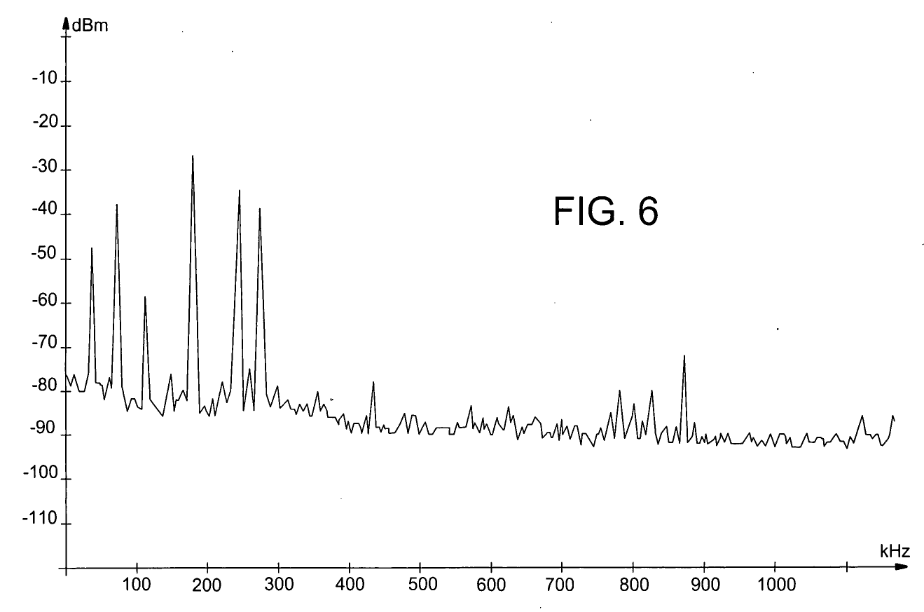

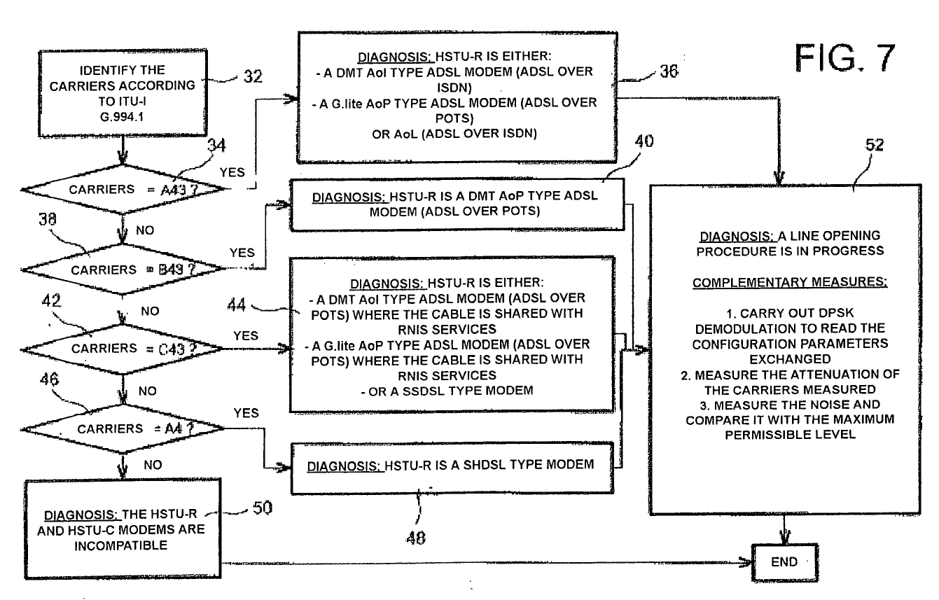

If a carrier such as that illustrated by FIG. 6 is detected, then the device deduces that a pair of HSTU-R and HSTU-C modems is active. The following step, illustrated by FIG. 7, consists of carrying out the steps 34 to 48 described in FIG. 5.

Contrary to the previous case, if the carrier does not belong to any of the standardised types described above, then in 50 the diagnosis is made that the HSTU-C and HSTU-R modems are incompatible.

Moreover, in this case regardless of the type of standardised carrier detected, the control module 14 emits the following diagnosis: a line opening procedure is in progress.

Then the measuring unit 14 carries out the following operations:

1. A DPSK demodulation to read the configuration parameters exchanged,

2. Measurement of the attenuation of the carriers detected,

3. Measurement of the noise and comparison of this measurement with the maximum permissible level according to the standard.

Case Where a Tone and/or a Disturbance are Detected:

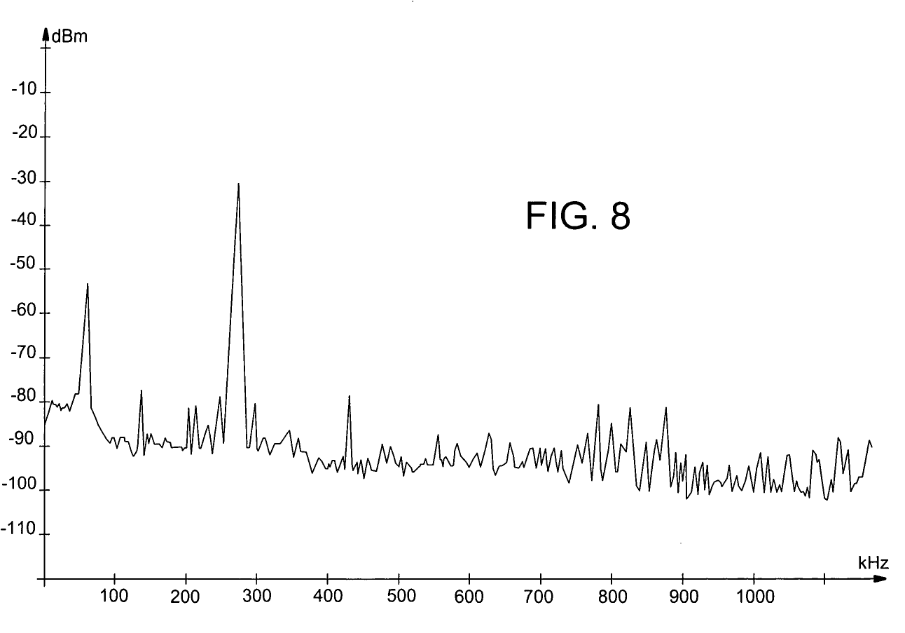

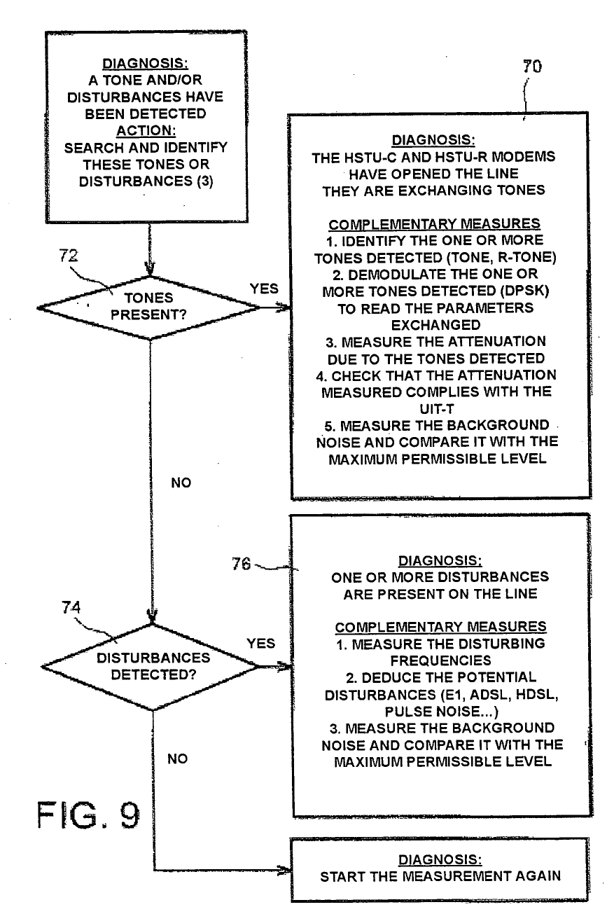

If a signal such as that illustrated in FIG. 8 is detected, then the device deduces that a tone and/or a disturbance are present on the line. The following step, illustrated by FIG. 9, consists of identifying these tones or these disturbances.

The measuring unit 14 carries out a first test (step 70) to check if the standardised tones are present on the line.

If they are present, the measuring unit 14 emits the following diagnosis (step 72): the HSTU-C and HSTU-R modems have opened their line and are exchanging tones. Then the measuring unit 14 carries out the following operations:

1. Identification of the one or more tones detected (C-Tone, R-Tone . . . )

2. Demodulation of the one or more tones detected (DPSK) to read the parameters exchanged,

3. Measurement of the attenuation of the tones detected,

4. Check that the attenuation measured complies with the G.994.1 standard,

5. Measurement of the background noise and comparison of the noise measured with the maximum permissible according to the G.994.1 standard.

If the standardised tones are not present on the line, the measuring unit 14 carries out a second test (step 74) to check if disturbing signals are present on the line.

If they are present, the measuring unit 14 carries out the following operations (step 76):

1. Measurement of the frequencies of the disturbing signals,

2. Deduction of the type of potential disturbing signals from the following types: E1, ADSL, HDSL, pulsed noise . . .

3. Measurement of the background noise and comparison of the noise measured with the maximum permissible according to the G.994.1 standard.

### Case Where Two HSTU-R and HSTU-C Modems are Synchronised

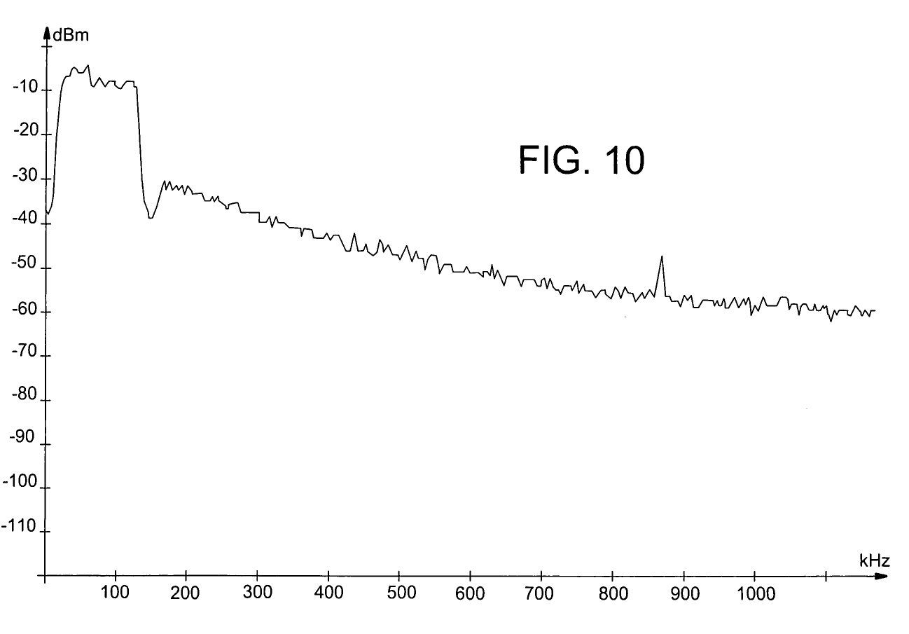

If a signal such as that illustrated by FIG. 10 is detected, then the measuring unit 14 deduces that two HSTU-R and HSTU-C modems are synchronised.

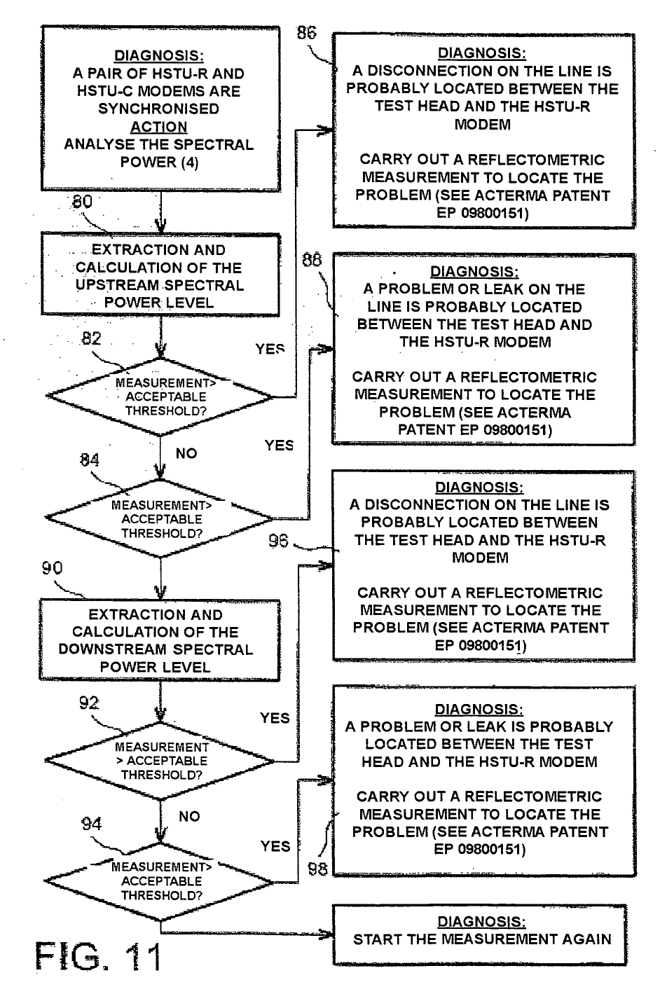

The following step, illustrated by FIG. 11, consists of carrying out a spectral analysis of the signal of FIG. 10 in both directions of transmission.

### Calculation of the Downstream Spectral Power

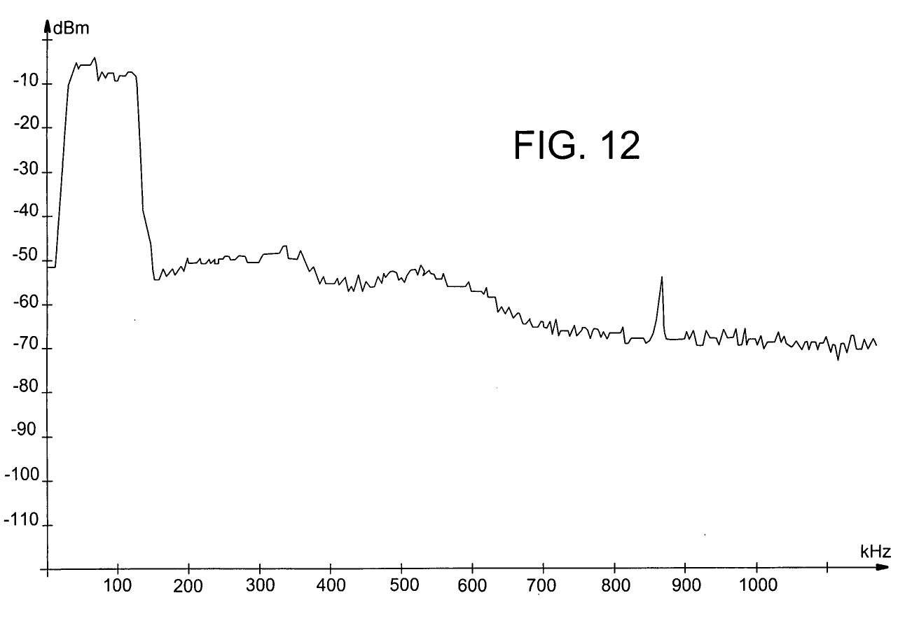

The measuring unit 14 carries out step 80 to extract and calculate the downstream spectral power. The part of the signal analysed is illustrated in FIG. 12.

The spectral power measured is then compared (step 82 and 84), to a predefined threshold value.

If this power is greater than the predefined threshold value, then the diagnosis (step 86) is made that there is a disconnection on the line between the measuring unit 14 and the HSTU-R modem a reflectometric measurement is carried out to locate the point of disconnection. One method of locating it is described in the patent application EP-0980151 registered by the applicant.

If the power measured is lower than the predefined threshold value (step 84), then the diagnosis (step 88) is made that there is a leak on the line between the measuring unit 14 and the HSTU-R modem and a reflectometric measurement is carried out to locate the point of the leak.

### Calculation of the Upstream Spectral Power

The measuring unit 14 carries out step 90 to extract and calculate the upstream spectral power.

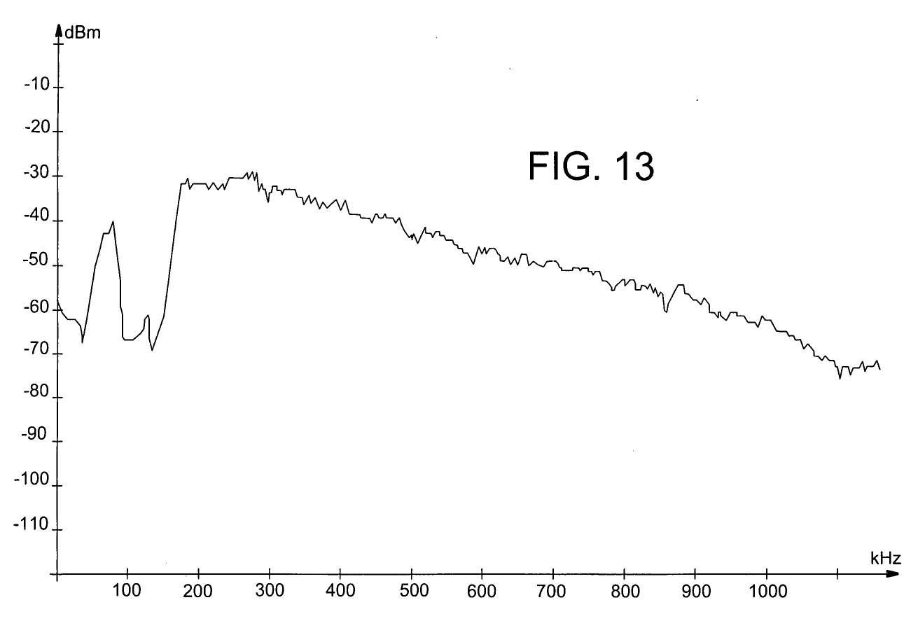

The part of the signal analysed is illustrated in FIG. 13.

The spectral power measured is then compared (step 92 and 94) to a predefined threshold value.

If this power is greater than the predefined threshold value (step 92), then the diagnosis (step 96) is made that there is a disconnection on the line between the measuring unit 14 and the HSTU-C modem and a reflectometric measurement is carried out to locate the point of the leak.

If the power measured is lower than the predefined threshold value (step 94), then the diagnosis (step 98) is made that there is a disconnection on the line between the measuring unit 14 and the HSTU-C modem and a reflectometric measurement is carried out to locate the point of the leak.

If none of the previous situations is detected, then the measurements are started again.

1. Non intrusive control process of an xDSL transmission line from signals and messages exchanged between at least one emitter (1) to at least one receiver (2) during a handshaking procedure, this process being characterised in that it comprises the following steps:
detecting and identifying the standardised carriers transmitted via the line to be controlled,
analysing the spectral power of the xDSL signals exchanged,
establishing a diagnosis on the state of the line according to the previous steps.

2. Process according to claim 1, characterised in that it further comprises a step consisting of disabling the communication via the wide band channel between the emitter (1) and the receiver (2) during a short instant so as to initialise a new handshaking procedure between the said emitter (1) and the said receiver (2).

3. Process according to claim 1, characterised in that the signals exchanged between the emitter (1) and the receiver (2) are defined by the ITU-T G.994.1 standard.

4. Process according to claim 3, characterised in that it consists of measuring the attenuation of the carriers detected to evaluate the distance between the telecommunications centre where the control equipment is installed and the subscriber.

5. Control device of an xDSL transmission line transporting several digital and/or analogue transmission channels, said device comprising a measuring unit (14) designed to evaluate the performances, search for the faults and establish la quality of the line and services transmitted, a switching module (16) capable of selectively connecting the measuring unit (14) solely to the transmission channels to be controlled and keep active the other channels of the transmission line, characterised in that it further comprises means for detecting and identifying standardised carriers transmitted via the line to be controlled, means for analysing the spectral power of the xDSL signals exchanged, and means for establishing a diagnosis on the state of the line according to the analysis of the xDSL signals exchanged.

6. Device of claim 5, characterised in that it further comprises means for disabling the communication via the wide band channel between the emitter (1) and the receiver (2) for a short instant so as to initialise a new handshaking procedure between the said emitter (1) and the said receiver (2).
